(19) United States
(12) Patent Application Publication
(10) Pub. No.: US 2003/0115323 A1
(43) Pub. Date: Jun. 19, 2003

(54) Apparatus for monitoring mainframe computer at remote location

(76) Inventor: Mun Hee Nam, Seoul (KR)

Correspondence Address: VENABLE, BAETJER, HOWARD AND CIVILETTI, LLP, P.O. BOX 34385, WASHINGTON, DC, 20043-9998, US

(21) Appl. No.: 10/322,643

(22) Filed: Dec. 19, 2002

(30) Foreign Application Priority Data
Dec. 19, 2001 (KR) 2001-81438

(51) Int. Cl. G06F 15/173

(52) U.S. Cl. 709/224

(57) ABSTRACT

An apparatus for monitoring a mainframe computer at a remote location is disclosed. The apparatus includes: mainframe analysis unit installed in the mainframe computer for analyzing jobs and events in the mainframe computer and outputting state information; main monitoring unit for creating a monitoring result based on the state information from the mainframe analysis unit by selecting and performing a treatment procedure corresponding to the state information and distributing the monitoring result through various communication networks, wherein the main monitoring unit is connected to the mainframe computer through a peer-to-peer connection protocol; and receiving unit for receiving the monitoring result from the main monitoring unit and informing the monitoring result to users. By the present invention, the state information of the mainframe computer can be monitored from any desired remote locations while the security of the mainframe computer is maintained.

### FIELD OF THE INVENTION

The present invention relates to an apparatus for monitoring a mainframe computer at a remote location; and, more particularly to an apparatus for rapidly and effectively monitoring a mainframe computer in realtime by transmitting states information of mainframe computer to receiving unit at the remote location through various communication networks while maintaining a security of the mainframe computer.

### DESCRIPTION OF RELATED ARTS

As growing a communication network such as the Internet wider and faster, a location of computer has gotten meaningless to users. The users monitor and control their computer at home or office in any remote locations through the communication network. Recently, a satellite communication network has become as one of structural elements of the communication network, it provides more freedom to the users from the location of the computer. The above-mentioned advantage of the communication network also gives one big problem to the user. There is a hacker to access information in other's computer without authorization by using open architecture of computer. Therefore, security issues of the Internet have been spotlighted recently.

The security issues are more important to a mainframe computer. The mainframe computer is a high-level system designed for the most intensive computational jobs. The mainframe computers have been used by large organizations for managing a mass size of database or controlling complicated computing jobs. Such characteristics of the mainframe computer have become attractive target for the hacker so the security issues are the most important principle for designing or administrating the mainframe computer. Therefore, the mainframe computer has been usually built as a closed architecture to the communication network. By maintaining the closed architecture of the mainframe computer, the mainframe computer guarantees security from attacks of the hacker.

By guaranteeing the security of the mainframe computer, an administrator of the mainframe computer loses the freedom of computer location for managing the mainframe computer. In the mainframe computer, if one of computation jobs or events causes a problem in the computer data processing business then the problem definitely invoke to suspense major data processing business matters of the corporation. Furthermore, it may cause to loss huge profit of the corporation or damage of corporation image. Therefore, the administrator must stay near by the mainframe computer for monitoring state of all computation jobs and critical system messages caused by the events, and responding corresponding them according to the problem.

However, in the most case, the problems are very seldom created in the mainframe computer. As a result, the administrator wastes time and man power in the most cases. Therefore, there has been demanded an apparatus for monitoring the operation state of jobs and critical system messages caused by the events in the mainframe computer at remote locations.

### SUMMARY OF THE INVENTION

It is, therefore, an object of the present invention to provide an apparatus for rapidly and effectively monitoring a mainframe computer in realtime by transmitting states information of the mainframe computer to receiving unit at the remote location through various communication networks while maintaining a security of the mainframe computer.

In accordance with an aspect of the present invention, there is provided an apparatus for monitoring a mainframe computer at a remote location, including: mainframe analysis unit installed in the mainframe computer for analyzing jobs and critical system messages in the mainframe computer and outputting state information; main monitoring unit for creating a monitoring result based on the state information from the mainframe analysis unit by selecting and performing a treatment procedure corresponding to the state information and distributing the monitoring result through various communication networks, wherein the main monitoring unit is connected to the mainframe computer through a peer-to-peer connection protocol; and receiving unit for receiving the monitoring result from the main monitoring unit and informing the monitoring result to users.

### BRIEF DESCRIPTION OF THE DRAWINGS

The above and other objects and features of the present invention will become apparent from the following description of the preferred embodiments given in conjunction with the accompanying drawings, in which:

FIG. 1 is a diagram illustrating an apparatus for monitoring a mainframe computer at a remote location in accordance with a preferred embodiment of the present invention;

FIG. 2 is a detailed diagram showing an apparatus for monitoring a mainframe computer at a remote location in accordance with a preferred embodiment of the present invention;

FIG. 3 shows an OPS digital tally display device for displaying state of job in the mainframe computer in accordance with the preferred embodiment of the present invention; and

FIG. 4 dispatches an OPS monitor system window displayed on a display device 240 in FIG. 2 for displaying state of job in the mainframe computer in accordance with the preferred embodiment of the present invention

### DETAILED DESCRIPTION OF THE INVENTION

Other objects and aspects of the invention will become apparent from the following description of the embodiments with reference to the accompanying drawings, which is set forth hereinafter.

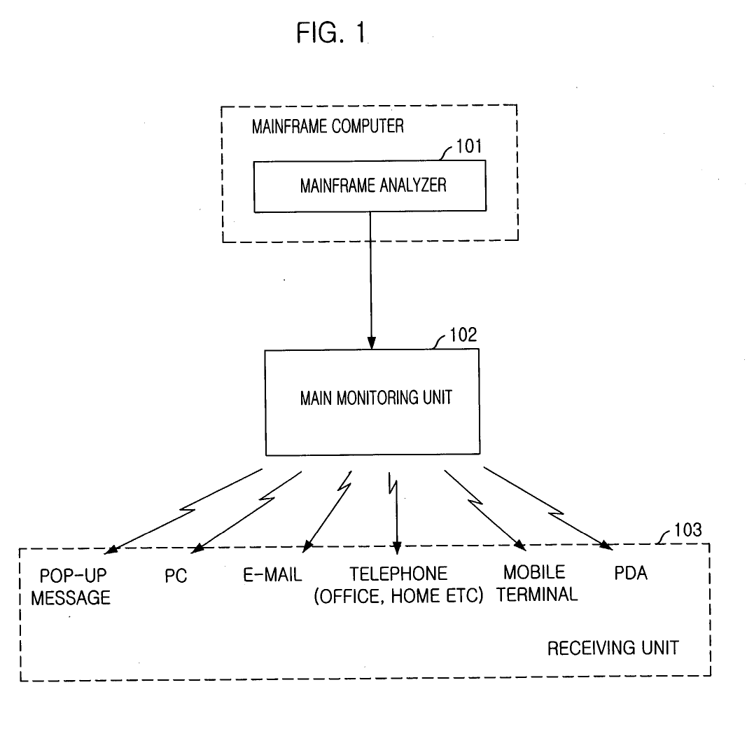

FIG. 1 is a diagram illustrating an apparatus for monitoring a mainframe computer at a remote location in accordance with a preferred embodiment of the present invention.

Referring to FIG. 1, the apparatus for monitoring a mainframe computer at a remote location includes a mainframe analyzer 101, a main monitoring unit 102 and receiving unit 103.

The mainframe analyzer 101 is equipped in a mainframe computer for monitoring and analyzing computation jobs and events in the mainframe computer. A job is a unit of work to be performed by the computer. The job is usually classified according to its operation state such as currently running jobs, jobs scheduled to run and abend jobs. The classified jobs are usually listed and stored in corresponding job queue. An event is an action such as moving or clicking a mouse or critical message caused by a system error. The mainframe analyzer 101 monitors activities of the jobs and events and analyzes states of the mainframe computer. After analyzing the activities of the jobs and events, the mainframe analyzer 101 transmits analysis results, which is states information of the mainframe computer, to the main monitoring unit 102 based on a peer-to-peer connection protocol, wherein the peer-to-peer connection protocol establishes a peer-to-peer connection for transmitting the state information of the mainframe computer to the main monitoring unit 102 and blocking unauthorized access from outside of the monitoring unit 102.

The main monitoring unit 102 receives the analysis result through the peer-to-peer connection. After receiving the analysis result, the main monitoring unit 102 selects a treatment procedure stored in a database according to the analysis result and creating a monitoring result of the mainframe computer. The monitoring result is converted to a monitoring result message, which is a predetermined format data, suitable for desired receiving unit and distributed to predetermined receiving unit by performing the treatment procedure. The monitoring result is transmitted not only to a display device for displaying the monitoring result based on a graphic user interface (GUI) applied from an operation system (OS) but also to various communication terminals such as a cellular phone, a telephone, a palmtop, a pager or a computer through a communication network. The communication network is also predetermined according to a type of receiving unit 103.

The receiving unit 103 includes any communication terminal such as a cellular phone, a telephone, a television set, a Fax machine, a beeper, a pager, a palmtop, a personal data assistant PDA or a personal computer PC.

By implementing the main monitoring unit 102, which is coupled to the communication network including the Internet, the mainframe computer can be monitored from any desired remote locations while the security of the mainframe computer is maintained. The above mentioned apparatus may rapidly and effectively alter an administrator of the mainframe computer according to a state of computation jobs in a realtime.

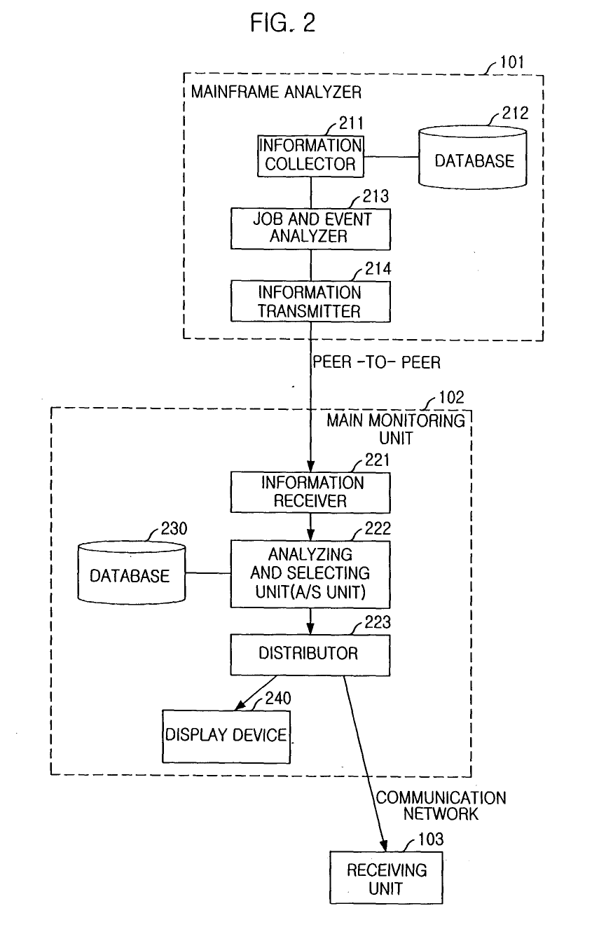

FIG. 2 is a detailed diagram showing an apparatus for monitoring a mainframe computer at a remote location in accordance with a preferred embodiment of the present invention.

Referring to FIG. 2, the mainframe analyzer 101 in the mainframe computer includes an information collector 211, a database 212, a job and event analyzer 213 and an information transmitter 214.

The information collector 211 monitors jobs and events in the mainframe computer and collects state information of the mainframe computer such as an operation state of job, an error state of job and event, an error message caused by the event and a time information. After collecting the state information, it is saved at the database 211 and outputted to the job and event analyzer 213.

The database 211 stores necessary information regarding to jobs and events. The information includes an operation state of job such as running, waiting and abend, an error state of job and event, time information such as starting time and termination time, a priority of job such as argent or normal, the error message of event and additional information such as a manual for handling jobs. The database 212 is coupled to the state collector 211, the job and event analyzer 213 and the information transmitter 214. The information stored in the database 212 can be updated according to the state of jobs and accessed from the state collector 211, the job and event analyzer 213 and the information transmitter 214.

The job and event analyzer 213 receives the state information and analyzes the state information of each job and event for classifying jobs and events in the mainframe computer according to state information and selecting the state information in order to transmit to the main monitoring unit 102. After analyzing, results of analyzing are stored in the database 212 and transmit the selected state information of job and event to the information transmitter 214.

The information transmitter 214 receives the state information of the mainframe computer selected at the job and event analyzer 213 and converts the state information to a state information message, which is a predetermined format of data. After creating the analysis result message, it is transmitted to the main monitoring unit 220 through the peer-to-peer connection. The peer-to-peer connection couples the mainframe analyzer 101 of the mainframe computer and the main monitoring unit 102.

As mentioned above, the mainframe analyzer 101 of the present invention monitors the jobs and events in the mainframe computer and sends the state information of the mainframe computer to the main monitoring unit 102, wherein the state information includes not only operation state of job but also critical system message caused by the events.

The main monitoring unit 102, as shown in FIG. 2, includes an information receiver 221, a analyzing and selecting unit (A/S unit) 222, a distributor 223, a display device 240 and a database 230.

The main monitoring unit 102 can be implemented as a stand alone device connected to a communication network or it can be implemented as an additional device installed in a computer connected to the communication network. The main monitoring unit 102 relays result of monitoring the mainframe computer from the mainframe computer to user's desired communication terminal through the communication network. Also, the main monitoring unit 102 blocks any accesses from outside of the main monitoring unit 102 to the mainframe computer. By the main monitoring unit 102, the mainframe computer can be indirectly connected to the communication network while maintaining the security of the mainframe computer from unauthorized access through the communication network. Therefore, the mainframe computer can be monitored at any desired remote locations with guaranteeing the security of the mainframe computer.

The information receiver 221 receives the state information message from the mainframe analyzer 101 and outputs the state information message to the analyzing and selecting unit (A/S unit) 222.

The A/S unit 222 receives the state information message from the information receiver 221. The state information message is analyzed at the A/S unit 222. The A/S unit 222 extracts state information from the state information message and finds corresponding treatment procedure in the database 230. The treatment procedure is predetermined according to characteristics of job and event such as the operation state, the class, and the priority. The treatment procedure contains a set of necessary computation jobs to perform according to the state information in order to send the state information to the receiving unit. The treatment procedure also contains additional information such as where to send monitoring result, how to send monitoring result and what information needs to send. The A/S unit 222 selects the corresponding treatment process and sends an analysis result containing the treatment process and the state information to the distributor 223.

The distributor unit 223 receives the analysis result from the A/S unit 222. The distributor 223 performs the set of computation jobs according to the treatment procedure in the analysis result. In other word, the distributor 223 creates a monitoring result message by converting the state information of the mainframe computer with additional information to the monitoring result message, which is a predetermined format of data according to the receiving unit 223 and the display device 240. The distributor 223 distributes the monitoring result message to the display unit 240 and the receiving unit 223 through various communication networks such as the telephone network, the Internet, the TV broadcasting network and the satellite network. The distributor 223 can send the monitoring result message to multiple receiving units simultaneously.

The display unit 240 includes a display device coupled to the main monitoring unit or a standalone display device such as electric display board or an OPS digital tally display device. The OPS digital tally display device is one of preferred embodiment of the display device designed and developed for the present invention by the applicant.

As mentioned above, the main monitoring unit 102 receives the state information of the mainframe computer from the mainframe analyzer 101 and passes the state information to the display device or at least one receiving unit through the various communication networks. The state information including operation state of jobs and critical system message caused by the event is arrived at the receiving unit or the display device for altering a user.

Therefore, the present invention. provides a way of monitoring the mainframe computer at the remote location. For example, if an administrator of the mainframe computer sets the main monitoring unit 102 to send the monitoring result messages including critical system message to a computer in home of the administrator and a cellular phone, then the monitoring result messages are transmitted to the computer and the cellular phone and displayed on a monitor attached to the computer as a window based on the graphic user interface (GUI) or displayed on a LCD device on the cellular phone as text message. Furthermore, if the main monitoring unit is set with condition to filtering specific message, then the main monitoring unit alters the user when a predetermined event is occurred in the mainframe computer.

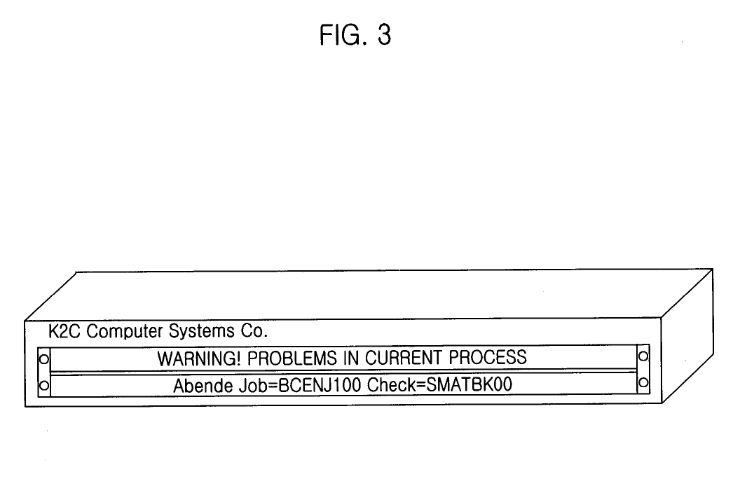

FIG. 3 shows an OPS digital tally display device. Referring to FIG. 3, the OPS digital tally display device is one of preferred embodiment of the display device designed and developed for the present invention. The OPS digital tally display device displays the monitoring result message and additional information corresponding to the state of job in the mainframe. The altering message may include text messages such as

“Abend job=JOB-A, JOB-B, . . . ”

“Check job=JOB-X, JOB-Y” and

“System problem (xxxxxx) happened!”.

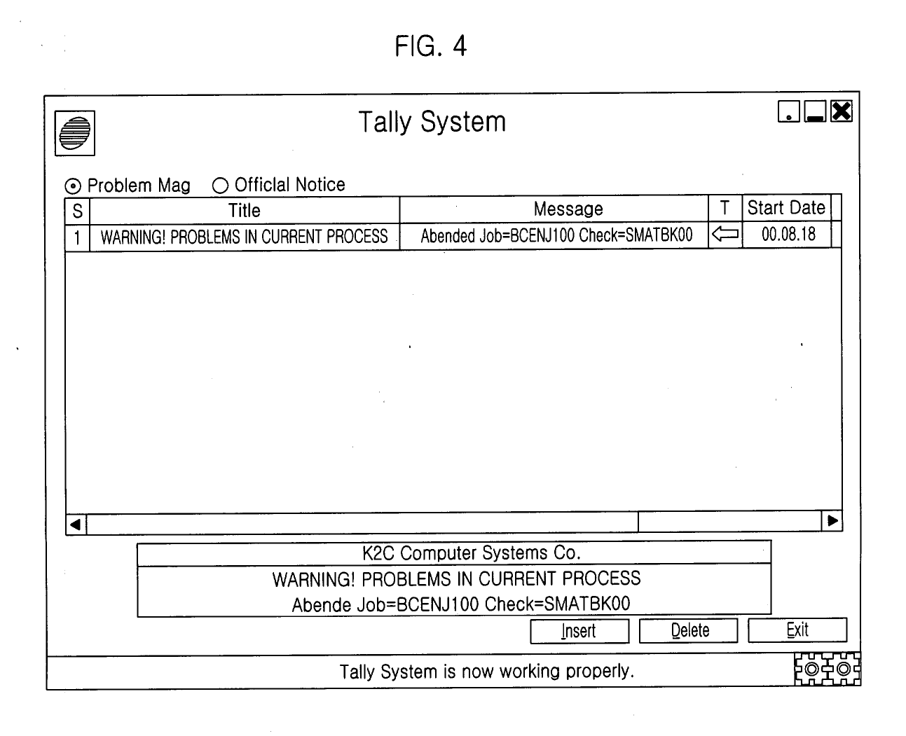

FIG. 4 shows an OPS monitor system window displayed on the display device 240 for monitoring state of job in the mainframe computer in accordance with the preferred embodiment of the present invention.

Referring to FIG. 4, the OPS monitor system window is a message window designed and developed for a preferred embodiment of the present invention based on a graphic user interface (GUI) supplied by the main monitoring unit or the monitor computer. It shows current operation state of the mainframe computer. It can be preset to be displayed not only to the display device but also to a console of the mainframe computer.

As mentioned above, by implementing the main monitoring unit 102, which is coupled to the communication network including the Internet, the state of the mainframe computer can be monitored from any desired remote locations while the security of the mainframe computer is maintained. Therefore, the above mentioned present invention may rapidly and effectively alter an administrator of the mainframe computer according to a state of computation jobs and events in a realtime.

While the present invention has been described with respect to certain preferred embodiments, it will be apparent to those skilled in the art that various changes and modifications may be made without departing from the scope of the invention as defined in the following claims.

What is claimed is:

1. An apparatus for monitoring a mainframe computer at a remote location, comprising:
mainframe analysis means installed in the mainframe computer for analyzing jobs and events in the mainframe computer and outputting state information;
main monitoring means for creating a monitoring result based on the state information from the mainframe analysis means by selecting and performing a treatment procedure corresponding to the state information and distributing the monitoring result through various communication networks, wherein the main monitoring means is connected to the mainframe computer through a peer-to-peer connection protocol; and
receiving means for receiving the monitoring result from the main monitoring means and informing the monitoring result to users.

2. The apparatus as recited in claim 1, wherein mainframe analysis means includes:
information collecting means for collecting state information of the mainframe computer by monitoring the jobs of the mainframe computer;
storage means for storing information such as a state of job, an error state of job and event, time information, a priority of job, a system message and additional information such as a manual for handling jobs;
job analyzing means for analyzing the state information and outputting an analysis result;
information transmitting means for converting the analysis result to the state information, which are predetermined format of data based on a protocol of the peer-to-peer connection and transmitting the state information to the main monitoring means.

3. The apparatus as recited in claim 1, wherein the main monitoring means includes:
information receiving means for receiving the state information from the information transmitting means;
storage means for storing treatment procedures corresponding to the state information;
analyzing and selecting means for analyzing the state information, selecting one of the treatment procedures and creating a monitoring result by performing the selected treatment procedure; and
distributing means for distributing the monitoring result to the receiving means by performing the treatment procedure.

4. The apparatus as recited in claim 3, further comprising display means for displaying the monitoring result based on a graphic user interface (GUI) supplied by an operating system (OS).

5. The apparatus as recited in claim 3, wherein the treatment procedure includes information and jobs to be performed in order to transmit the monitoring result to the receiving means.

6. The apparatus as recited in claim 3, wherein the state information includes a critical system message caused by the events in the mainframe computer.

7. The apparatus as recited in claim 1, wherein the main monitoring means transmits the monitoring result through at least one communication network to the receiving means, wherein the communication network includes the Internet, a telephone communication network, a television TV broadcast network and a satellite communication network.

8. The apparatus as recited in claim 1, wherein the receiving means includes a telephone, a cellular phone, a beeper, a pager, a palmtop, a personal data assistant (PDA) and a personal computer.
